(19) United States
(12) Patent Application Publication
(10) Pub. No.: US 2024/0317350 A1
(43) Pub. Date: Sep. 26, 2024

(54) BICYCLE AND SCOOTER SMART SAFETY DEVICE

(71) Applicant: Alisha Dove, Virginia Beach, VA (US)

(72) Inventor: Alisha Dove, Virginia Beach, VA (US)

(21) Appl. No.: 18/186,910

(22) Filed: Mar. 20, 2023

(51) Int. Cl. B62J 50/21; B62J 3/10; B62J 6/05; B62J 6/24; B62J 45/20; B62J 45/41; B62J 45/42; B62J 50/22; B62K 21/26

(52) U.S. Cl. CPC B62J 50/225; B62J 3/10; B62J 6/05; B62J 6/24; B62J 45/20; B62J 45/41; B62J 45/42; B62J 50/22; B62K 21/26; B62J 1/28; B62J 6/028; B62J 45/415; B62K 23/02

(57) ABSTRACT

A smart safety device for a bicycle or scooter is disclosed. The smart safety device includes a pair of handlebar grips configured to be removably coupled to a handlebar of the bicycle or scooter. Each handlebar grip includes at least one object detection sensor to detect traffic in the vicinity of the handlebar, and at least one vibrator configured to vibrate based on input from the at least one object detection sensor. Moreover, the smart safety device includes a user interface mounted substantially centrally to the handlebar and including at least one detector to detect traffic in front of the bicycle or scooter. The user interface also includes at least one indicator configured to indicate a presence of an object in front of the bicycle or scooter based on input from the at least one detector.

### BACKGROUND OF THE INVENTION

Children enjoy riding bicycles and scooters, which provide great opportunities for fun and exercise. Unfortunately, accidents happen. For example, every year thousands of kids need to see a doctor or go to the emergency room due to bicycle injuries. Many of such injuries are caused by accidents between the cyclist and motor vehicles such as cars or trucks.

In addition, while children are out riding their bicycles and scooters, parents worry about their whereabouts and about the danger of potential kidnappers.

Therefore, there is a need for a safety device that can be mounted to bicycles or scooters and provide child riders and their parents with increased awareness of nearby traffic and other data to monitor the rider's safety.

### SUMMARY OF THE INVENTION

To address the foregoing problems, in whole or in part, and/or other problems that may have been observed by persons skilled in the art, the present disclosure provides compositions and methods as described by way of example as set forth below.

A smart safety device for a bicycle is disclosed. The smart safety device includes a pair of handlebar grips configured to be removably coupled to a handlebar of the bicycle. Each handlebar grip includes at least one object detection sensor to detect traffic in the vicinity of the handlebar, and at least one vibrator configured to vibrate based on input from the at least one object detection sensor. Moreover, the smart safety device includes a user interface mounted substantially centrally to the handlebar and including at least one detector to detect traffic in front of the bicycle. The user interface also includes at least one indicator configured to indicate a presence of an object in front of the bicycle based on the input from the at least one detector.

In some embodiments, the smart safety device includes a seat including at least one object detector arranged at a rear end of the seat to detect an approaching object from a rear of the bicycle. The seat also includes a vibrator adapted to vibrate in response to the detection of the approaching object based on input from the at least one object detector.

In some embodiments, the smart safety device includes at least one impact sensor configured to detect a falling of the bicycle or an impact of the bicycle with an object.

In some embodiments, the smart safety device includes a location sensor configured to determine a location of the bicycle, wherein the smart safety device is configured to share the location of the bicycle with a mobile device of a guardian.

In some embodiments, the smart safety device is configured to share the location of the bicycle with the mobile device based on input from the at least one impact sensor.

In some embodiments, the smart safety device includes a panic button configured to be actuated by a rider in emergency. Upon actuation of the panic button, a message including the location of the bicycle is shared with the mobile device.

In some embodiments, the user interface includes at least one camera to capture a view of surrounding of the bicycle.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF DRAWINGS

Having thus described the subject matter of the present invention in general terms, reference will now be made to the accompanying drawings, which are not necessarily drawn to scale.

FIG. 1 illustrates a perspective view of a bicycle equipped with a safety device, in accordance with an embodiment of the disclosure;

FIG. 2 illustrates a front perspective view of a handlebar grip of the smart safety device of FIG. 1, in accordance with an embodiment of the disclosure;

FIG. 3 illustrates a top rear perspective view of a seat of the smart safety device of FIG. 1, according to an alternative embodiment of the disclosure;

FIG. 4 illustrates a front view of a user interface of the smart safety device of FIG. 1, in accordance with an embodiment of the disclosure;

FIG. 5 illustrates a rear of the user interface of the smart safety device of FIG. 1, in accordance with an embodiment of the disclosure; and

FIG. 6 illustrates a perspective view of a scooter equipped with a smart safety device from which the seat is omitted, in accordance with an embodiment of the disclosure.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. Therefore, it is to be understood that the subject matter of the present invention is not to be limited to the specific embodiments disclosed and that modifications and other embodiments are intended to be included within the scope of the appended claims.

### Bicycle and Scooter Smart Safety Device

In one embodiment, a bicycle smart safety device is provided, comprising:
a. a first handlebar grip and a second handlebar grip that are each configured to be removably mounted to a handlebar of a bicycle, wherein the first handlebar grip is arranged at a first end of the handlebar and the second handlebar grip is arranged at a second end of the handlebar, wherein the first and second handlebar grips each separately comprise a first and second grip body, a first and second grip portion, and a first and second cap portion, respectively, wherein:
   i. the first grip body comprises a first object detection sensor, a first vibrator, and a first light, wherein the first object detection sensor comprises a first motion and/or proximity sensor configured to detect a presence of a first moving and/or stationary object in the vicinity of the first grip body and trigger the first vibrator and/or the first light to alert the rider to the presence of the first moving and/or stationary object; and
   ii. the second grip body comprises a second object detection sensor, a second vibrator, and a second light, wherein the second object detection sensor comprises a second motion and/or proximity sensor configured to detect a presence of a second moving and/or stationary object in the vicinity of the second grip body and trigger the second vibrator and/or the second light to alert the rider to the presence of the second moving and/or stationary object;
b. a seat configured to be removably mounted on a seat post of the bicycle, comprising a seat body comprising a front end, a rear end, and first and second sides extending from the front end to the rear end, and further comprising a plurality of sensors comprising:
   i. a third object detection sensor and a third vibrator that are each disposed in the first side of the seat body, wherein the third object motion detection sensor comprises a third motion and/or proximity sensor configured to detect a presence of a third moving and/or stationary object in the vicinity of the first side of the seat body and trigger the third vibrator to alert the rider to the presence of the third moving and/or stationary object;
   ii. a fourth object detection sensor and a fourth vibrator that are each disposed in the second side of the seat body, wherein the fourth object motion detection sensor comprises a fourth motion and/or proximity sensor configured to detect a presence of a fourth moving and/or stationary object in the vicinity of the second side of the seat body and trigger the fourth vibrator to alert the rider to the presence of the fourth moving and/or stationary object;
   iii. a fifth object detection sensor and a fifth vibrator that are each disposed in the rear end of the seat body, wherein the fifth object motion detection sensor comprises a fifth motion and/or proximity sensor configured to detect a presence of a fifth moving and/or stationary object in the vicinity of the rear end of the seat body and trigger the fifth vibrator to alert the rider to the presence of the fifth moving and/or stationary object; and
   iv. a first fall and/or impact sensor disposed centrally in the seat body and configured to detect when the bicycle falls and/or when the bicycle impacts one or more objects; and
   v. a pair of turn signal indicators comprising a first turn signal indicator configured to be actuated in response to actuation of a first turn signal trigger disposed in the first handlebar grip, and a second turn signal indicator configured to be actuated in response to actuation of a second turn signal trigger disposed in the second handlebar grip; and
c. a user interface removably mounted to the handlebar, comprising;
   i. a sixth object detection sensor comprising a sixth motion and/or proximity sensor configured to detect a presence of a sixth moving and/or stationary object in the vicinity of the user interface and trigger at least one indicator disposed within the user interface to alert the rider to the presence of the sixth moving and/or stationary object, wherein the at least one indicator comprises one or more lights configured to be actuated in response to input received from the sixth motion and/or proximity sensor;
   ii. a front camera configured to capture a view in front of the bicycle and a rear camera configured to capture a view of the rider; wherein the front and rear cameras are configured to be in communication with a mobile device of a guardian of the rider and share images and/or video to the mobile device;
   iii. at least one speaker configured to be paired with the mobile device of the guardian and enable audio and/or voice communication from the guardian to the rider, and wherein the at least one speaker is also configured to provide audio alerts to the rider based on input from the sixth motion and/or proximity sensor;
   iv. a second fall and/or impact sensor configured to detect when the bicycle falls and/or when the bicycle impacts one or more objects;
   v. a panic button adapted to be operated by the rider and configured to trigger a distress signal that is transmitted to the mobile device when the panic button is operated to inform the guardian that the rider needs help;
   vi. a headlight configured to illuminate an area in front of the bicycle;
   vii. a location sensor configured to determine a location of the bicycle and transmit the location to the mobile device to enable the guardian to monitor the location of the bicycle in real time;
   viii. a transceiver configured to facilitate a communication and date exchange between the mobile device and a controller; and
   ix. a controller comprising a processor operatively connected to a memory for storing instructions for controlling functions of the safety device, wherein the controller is configured to:
      aa. receive input from the first, second, third, fourth, and/or fifth object detection sensors and actuate the first, second, third, fourth, and/or fifth vibrators, respectively, when the first, second, third, fourth, and/or fifth moving and/or stationary objects are detected, wherein the controller is further configured to control a frequency and intensity of vibration based on a distance of the first, second, third, fourth, and/or fifth moving and/or stationary objects from the bicycle;
      bb. receive input from the first and/or second fall and/or impact sensors and communicate the occurrence of a fall and/or impact and/or the location of the bicycle to the mobile device through the transceiver;
      cc. facilitate a voice-based communication between the guardian and the rider through the speaker via the mobile device;
      dd. communicate the distress signal and/or the location of the bicycle to the mobile device in response to the actuation of the panic button by the rider;
      ee. communicate the location of the bicycle to the mobile device when a fall and/or impact is detected and/or when the panic button is actuated;
      ff. receive input from the first, second, third, fourth, and/or fifth object detection sensors, determine whether it is safe to ride or not, and actuate the one or more indicators to notify the rider of traffic and/or guide the rider to navigate through and/or around traffic; and
      gg. receive input from the first and/or second turn signal triggers and actuate the respective first and/or second turn signal indicators.

In some aspects, the grip body has a substantially hollow cylindrical shape and is configured to receive a portion of the handlebar. In some aspects, the grip portion is adapted to be held by a rider. In some aspects, the cap portion is arranged at an end of the grip portion. In some aspects, in response to the receipt of the distress signal, the user interface enables voice communication from the guardian via the mobile device to the rider via the at least one speaker. In some aspects, the front camera and/or rear camera are configured to make a recording of the fall and/or impact and communicate the recording to the guardian via the mobile device. In some aspects, the location sensor comprises a global positioning system. In some aspects, if the controller determines that it is not safe to ride, the one or more indicators comprise a warning light.

In another embodiment, a smart scooter safety device, comprising:
a. a first handlebar grip and a second handlebar grip that are each configured to be removably mounted to a handlebar of a scooter, wherein the first handlebar grip is arranged at a first end of the handlebar and the second handlebar grip is arranged at a second end of the handlebar, wherein the first and second handlebar grips each separately comprise a first and second grip body, a first and second grip portion, and a first and second cap portion, respectively, wherein:
   i. the first grip body comprises a first object detection sensor, a first vibrator, and a first light, wherein the first object detection sensor comprises a first motion and/or proximity sensor configured to detect a presence of a first moving and/or stationary object in the vicinity of the first grip body and trigger the first vibrator and/or the first light to alert the rider to the presence of the first moving and/or stationary object; and
   ii. the second grip body comprises a second object detection sensor, a second vibrator, and a second light, wherein the second object detection sensor comprises a second motion and/or proximity sensor configured to detect a presence of a second moving and/or stationary object in the vicinity of the second grip body and trigger the second vibrator and/or the second light to alert the rider to the presence of the second moving and/or stationary object; and
b. a third object detection sensor positioned on a rear portion of the scooter, comprising a third motion and/or proximity sensor configured to detect a presence of a third moving and/or stationary object in the vicinity of the rear portion of the scooter and trigger at least one indicator disposed within the user interface to alert the rider to the presence of the third moving and/or stationary object, wherein the at least one indicator comprises one or more vibrators and/or one or more lights configured to be actuated in response to input received from the third motion and/or proximity sensor;
c. a user interface removably mounted to the handlebar, comprising;
   i. a front camera configured to capture a view in front of the scooter and a rear camera configured to capture a view of the rider; wherein the front and rear cameras are configured to be in communication with a mobile device of a guardian of the rider and share images and/or video to the mobile device;
   ii. at least one speaker configured to be paired with the mobile device of the guardian and enable audio and/or voice communication from the guardian to the rider, and wherein the at least one speaker is also configured to provide audio alerts to the rider based on input from the sixth motion and/or proximity sensor;
   iii. a fall and/or impact sensor configured to detect when the scooter falls and/or when the scooter impacts one or more objects;
   iv. a panic button adapted to be operated by the rider and configured to trigger a distress signal that is transmitted to the mobile device when the panic button is operated to inform the guardian that the rider needs help;
   v. a headlight configured to illuminate an area in front of the scooter;
   vi. a location sensor configured to determine a location of the scooter and transmit the location to the mobile device to enable the guardian to monitor the location of the scooter in real time;
   vii. a transceiver configured to facilitate a communication and date exchange between the mobile device and a controller; and
   viii. a controller comprising a processor operatively connected to a memory for storing instructions for controlling functions of the safety device, wherein the controller is configured to:
      aa. receive input from the first, second, third, fourth, and/or fifth object detection sensors and actuate the first, second, third, fourth, and/or fifth vibrators, respectively, when the first, second, third, fourth, and/or fifth moving and/or stationary objects are detected, wherein the controller is further configured to control a frequency and intensity of vibration based on a distance of the first, second, third, fourth, and/or fifth moving and/or stationary objects from the scooter;
      bb. receive input from the first and/or second fall and/or impact sensors and communicate the occurrence of a fall and/or impact and/or the location of the scooter to the mobile device through the transceiver;
      cc. facilitate a voice-based communication between the guardian and the rider through the speaker via the mobile device;
      dd. communicate the distress signal and/or the location of the scooter to the mobile device in response to the actuation of the panic button by the rider;
      ee. communicate the location of the scooter to the mobile device when a fall and/or impact is detected and/or when the panic button is actuated; and
      ff. receive input from the first, second, and/or third object detection sensors, determine whether it is safe to ride or not, and actuate the one or more indicators to notify the rider of traffic and/or guide the rider to navigate through and/or around traffic.
         In some aspects, the grip body has a substantially hollow cylindrical shape and is configured to receive a portion of the handlebar. In some aspects, the grip portion is adapted to be held by a rider. In some aspects, the cap portion is arranged at an end of the grip portion. In some aspects, in response to the receipt of the distress signal, the user interface enables voice communication from the guardian via the mobile device to the rider via the at least one speaker.

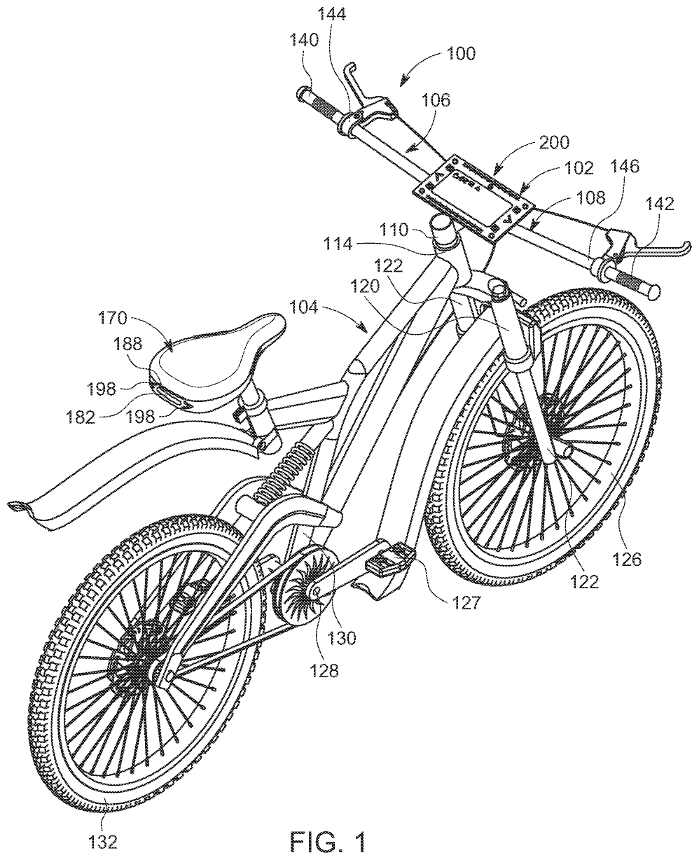

Referring to FIG. 1, a bicycle, for example, a bicycle 100, equipped with a smart safety device 102 is disclosed. The bicycle 100 includes a frame 104, a handlebar assembly 106 having a handlebar 108 and a handlebar mount 110 mounted on an upper end of a head cylinder 114 of the frame 104 with the handlebar mount 110 being rotatably mounted on bearings in an open upper end of the head cylinder 114. A fork assembly 120 having a pair of spaced forks 122 is arranged on each side of a front wheel 126 and connected to the front wheel 126 and a fork steering cylinder (not shown) extends upwardly into an interior of the head cylinder 114, where it operably engages with the handlebar mount 110.

In an embodiment, the bicycle 100 is powered by a conventional pedal mechanism 127 attached to a bottom bracket shell 128 at a bottom of a seat post 130. In an embodiment, the bicycle 100 may be powered by an electric motor and an electric battery connected to the pedal mechanism 127. The pedal mechanism 127 is operatively connected to a rear wheel 132 of the bicycle 100 to drive the bicycle 100.

The smart safety device 102 is configured to protect and keep a rider, for example, a child, safe while riding. As shown, the smart safety device 102 includes a pair of handlebar grips, for example, a first handlebar grip 140 and a second handlebar grip 142 removably mounted to the handlebar 108 and arranged at two lateral ends of the handlebar 108. As shown, the first handlebar grip 140 is arranged at a first end 144 (i.e., left end 144) of the handlebar 108 and the second handlebar grip 142 is arranged at a second end 146 (i.e., right end 146) of the handlebar 108. The first handlebar grip 140 and the second handlebar grip 142 are identical to each other, and therefore, for the sake of clarity and brevity, a structure, construction, and assembly of only one handlebar grip, for example, the first handlebar grip 140 is explained.

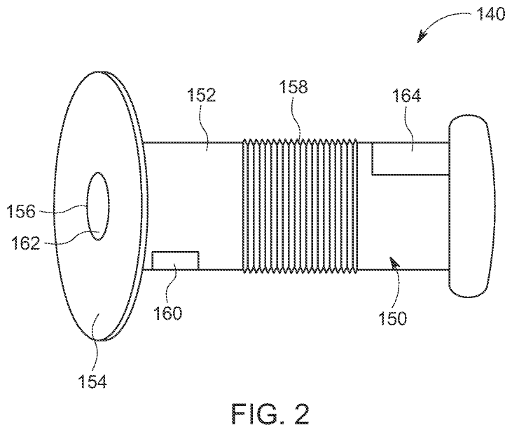

Referring to FIG. 2, the first handlebar grip 140 includes a grip body 150 having a substantially hollow cylindrical shape defining an elongated channel (not shown) to receive a portion of the handlebar 108 and to facilitate sleeving/mounting of the first handlebar grip 140 onto the handlebar 108. The grip body 150 includes a grip portion 152 adapted to be held by the rider and a cap portion 154 arranged at an end of the grip portion 152 and closing the elongated channel at one end of the grip body 150. Further, the first handlebar grip 140 includes at least one object detection sensor 156, at least one vibrator 158, and at least one light 160 mounted on the grip body 150. As shown, the at least one object detection sensor 156 includes a motion sensor 162 mounted to the cap portion 154 and is arranged at an end of the grip body 150.

The motion sensor 162 is configured to detect a presence of a moving object in the vicinity of the bicycle 100. Accordingly, the motion sensor 162 of the first handlebar grip 140 is configured to sense traffic on a left side of the bicycle 100. Additionally, or optionally, the at least one object detection sensor 156 may include a proximity sensor to detect an object (stationary or moving) in proximity to the bicycle 100. Based on the traffic detected by the at least one object detection sensor 156, the at least one vibrator 158 and/or the at least one light 160 of the first handlebar grip 140 is actuated to alert the rider a presence of the traffic on the left side of the bicycle 100. Similarly, the vibrator and/or the light of the second handlebar grip 142 are actuated in response to the detection of the traffic on a right side of the bicycle 100. In some embodiments, the first handlebar grip 140 may include a turn signal trigger 164 to be actuated/pressed by the rider to indicate a turning direction of the bicycle. The turn signal trigger 164 of the first handlebar grip 140 actuates a left turn signal, while a turn signal trigger associated with the second handlebar grip 142 may actuate a right turn signal of the bicycle 100.

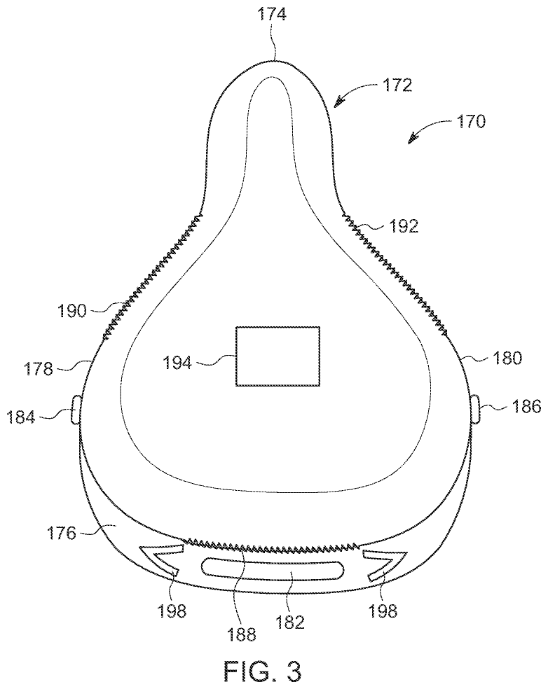

Further, as shown in FIG. 3, the smart safety device 102 includes a seat 170 mounted on the seat post 130 of the frame 104 and having a seat body 172 including a front end 174, a rear end 176, a first side 178 (left side) and a second side 180 (right side) extending from the front end 174 to the rear end 176. The seat 170 also includes a plurality of sensors, for example, at least one object detector, for example, a first object detector 182, a second object detector 184, and a third object detector 186, configured to detect object (moving or stationary) in the vicinity of the seat 170. In some embodiments, the at least one object detector may include a motion sensor and/or a proximity sensor to detect the traffic in the vicinity of the seat 170. The first object detector 182 is arranged at the rear end 176 of the seat 170 to detect/sense the traffic/objects approaching the bicycle 100 from a rear of the bicycle 100. The second object detector 184 is arranged on the first side 178 of the seat 170 to detect a presence of the traffic and/or object on the left side of bicycle 100 and in the vicinity of the seat 170, while the third object detector 186 is disposed on the second side 180 of the seat 170 to detect a presence of the traffic and/or object on the right side of bicycle 100 and in the vicinity of the seat 170. Similar to the handlebar grips 140, 142, the seat 170 also include at least one vibrator arranged in communication with the at least one object detection sensor. For example, a fifth vibrator 188, a third vibrator 190, and a fourth vibrator 192 are respectively arranged in communication with the first object detector 182, the second object detector 184, and the third object detector, and configured to actuate based on input received from the object detectors 182, 184, 186.

As shown in FIG. 3, the fifth vibrator 188 is arranged at the rear end 176 of the seat 170 to induce vibration in the vicinity of rear end 176 of the seat body 172 to indicate the presence of object or traffic at the rear of the bicycle 100. Similarly, the third vibrator 190 and the fourth vibrator 192 are arranged, respectively, at the first side 178 and the second side 180 of the seat body 172 to induce vibration in the first side 178 and the second side 180 of the seat body 172, respectively, to indicate the presence of object or traffic at the left side and the right side of the bicycle 100 and in the vicinity of the seat 170. Moreover, the seat 170 includes at least one fall/impact sensor 194 arranged centrally to the seat body 172, as shown in FIG. 3. The fall/impact sensor 194 is configured to detect an impact of the bicycle 100 with another object or falling of the bicycle 100 to a ground. In some embodiments, the seat 170 further includes a pair of turn signal indicators 198 (i.e., a left turn signal indicator and a right turn signal indicator) in order to inform tailing vehicles about the turning direction of the bicycle 100. The turn signal indicators 198 are actuated in response to the actuation of the turn signal triggers 164 of the handlebar grips 140, 142.

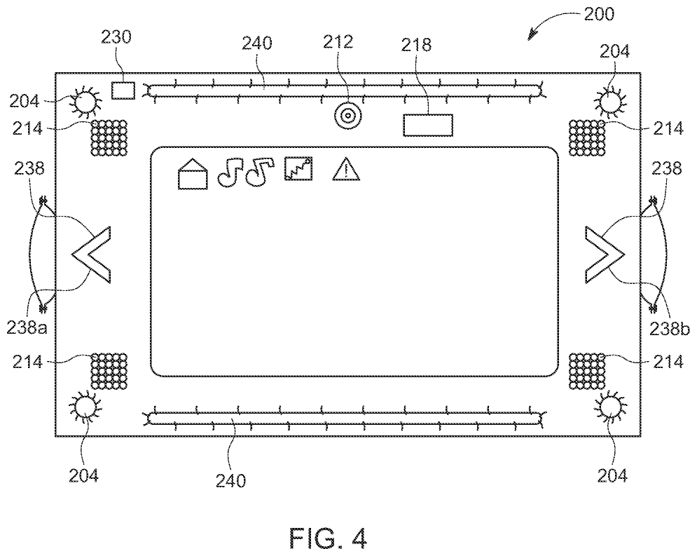

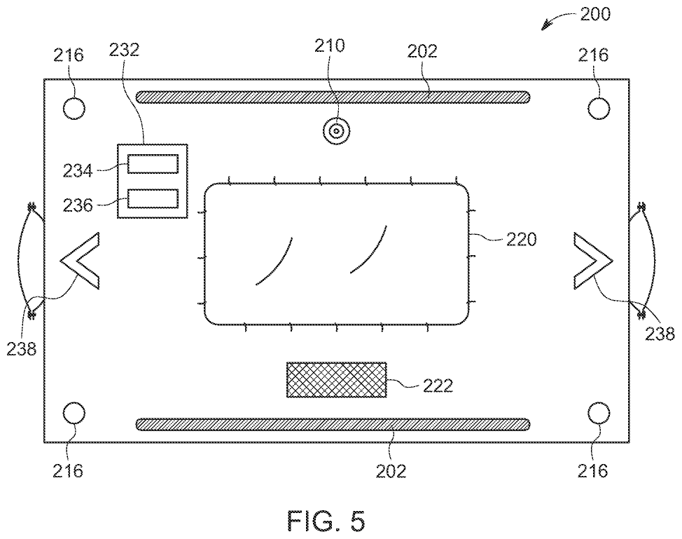

Additionally, referring to FIG. 4 and FIG. 5, the smart safety device 102 includes a user interface 200 arranged substantially centrally to the handlebar 108 and removably mounted to the handlebar 108. The user interface 200 includes at least one detector 202, for example, two detectors 202, to detect/sense object/traffic (moving and/or stationary) present in front of the bicycle 100. Further, the user interface 200 includes at least one indicator 204 arranged in communication with the at least one detector 202 and configured to indicate a presence of the object/traffic in front of the bicycle 100 to the rider. In some embodiments, the at least one indicator 204 includes one or more vibrators configured to vibrate in response to detection of the traffic/object in front of the bicycle 100. Additionally, or optionally, the at least one indicator 204 may include at least one light configured to be actuated in response to input received from the at least one detector 202. In some embodiments, the at least one light may include one or more of orange light and red light to indicate a distance of object and intensity of traffic in front of the bicycle 100.

Moreover, the user interface 200 includes at least one camera, for example, a front camera 210 to capture a view of a front of the bicycle and a rear camera 212 to capture a view of the rider. The cameras 210, 212 are in communication with a mobile device of a guardian of the rider and provides/shares captured images/video to the mobile device. Further, the user interface 200 includes at least one speaker 214 to enable a communication of the guardian with the rider or to provide audio alerts to the rider based on the input from one or more sensors of smart safety device 102. In an embodiment, the speaker 214 is actuated to provide audio alerts to the rider based on the input from the at least one detector 202. Also, the speaker 214 is configured to be paired with the mobile device of the guardian, and the audio/voice messages received from the mobile device is delivered to the rider through the speaker 214. The speaker 214 may also be synced with the mobile device to play music through the speaker 214.

Additionally, the user interface 200 may include at least one impact sensor 216 to detect a falling or a collision of the bicycle 100 with another object. Moreover, the user interface 200 includes a panic button 218 adapted to be operated by the rider. It may be appreciated that a suitable alert, for example, a distress signal, is transmitted to the mobile device when the panic button 218 is operated to inform the guardian that the rider needs help. In some embodiments, in response to the receipt of the distress signal, the user interface 200 facilitates the guardian to speak and communicate with the rider through the paired mobile phone and the speaker 214. Moreover, in some embodiments, one or more cameras, for example, the rear camera 212 may record the incident and shares the recorded view with the guardian through the mobile device. Further, the user interface 200 includes a headlight 220 to illuminate an area in front of the bicycle 100.

In some embodiments, the user interface 200 may also include a location sensor 222, for example, a global positioning system, to determine a location of the bicycle 100. The location of the bicycle 100 may be transmitted to the mobile device to enable the guardian to monitor the location of the bicycle 100 in real time. In some embodiments, the location is transmitted to the mobile device in response to the detection of the impact of bicycle 100 with an object or the falling of the bicycle 100. In some embodiments, the location of the bicycle 100 may also be transmitted to the mobile device in response to actuation of the panic button 218.

Further, the user interface 200 includes a transceiver 230 configured to facilitate a communication and date exchange between the mobile device and a controller 232 or other components of the smart safety device 102. In an embodiment, the transceiver 230 may enable a short-range communication or a long-range communication.

The controller 232 may include a processor 234 for executing specified instructions, which controls and monitors various functions associated with the components of the smart safety device 102. The processor 234 may be operatively connected to a memory 236 for storing instructions related to the control and functioning of the smart safety device 102. The memory 236 as illustrated is integrated into the controller 232, but those skilled in the art will understand that the memory 236 may be separate from the controller 232 but onboard the smart safety device 102, and/or remote from both the controller 232 and the smart safety device 102, while still being associated with and accessible by the controller 232 to store information in and retrieve information from the memory 236 as necessary during the operation of the smart safety device 102. Although the processor 234 is shown, it is also possible and contemplated to use other electronic components such as a microcontroller, an application specific integrated circuit (ASIC) chip, or any other integrated circuit device. Moreover, the controller 232 may refer collectively to multiple control and processing devices across which the functionality of the smart safety device 102 may be distributed. For example, the speaker 214, impact sensors 194, 216 the objector detection sensors 156, object detectors 182, 184, 186, the detector 202, the panic button 218, the transceiver 230, the headlight 220, the cameras, 210, 212, the vibrators 158, 188, 190, 192, the indicators 204, etc., may each have one or more controllers that communicate with the controller 232.

The controller 232 is configured to receive input from the object detection sensors 156 of the handlebar grips 140, 142 and is configured to actuate the associated vibrator 158 when the object/traffic is detected. The controller 232 may be configured to control a frequency and intensity of the vibration based on a distance of the detected object from the bicycle 100. For example, the controller 232 may cause a light vibration through the vibrator 158 when the distance between the object and the bicycle 100 is relatively large and increase the frequency and/or intensity of the vibrations generated by the associated vibrator 158 as object comes near to the bicycle 100. Further, the controller 232 may also be configured to actuate the lights 160 of the handlebar grips 140, 142 based on inputs received from the object detection sensors 156. Similar to the object detection sensors 156 and vibrators 158 of the handlebar grips 140, 142, the controller 232 may be arranged in communication with the object detectors 182, 184, 186 of the seat 170, and may cause actuation of the associated vibrators 188, 190, 192 based on input received from one or more object detectors 182, 184, 186 of the seat 170. Moreover, the controller 232 is arranged in communication with the impact sensors 194, 216 and determine the impact or falling of the bicycle 100 based on inputs received from the impact sensors 194, 216. Further, the controller 232 may share a message to the mobile device through the transceiver 230 in response to the determination of the impact of the bicycle 100 with an object or ground. Also, the controller 232 may facilitate a voice-based communication between the guardian and the rider through the speaker 214 and the mobile device.

Further, the controller 232 is configured to share the distress signal to the mobile device in response to the actuation of the panic button 218 by the rider. Moreover, the controller 232 is arranged in communication with the location sensor 222 and is configured to share the location data of the bicycle 100 when the impact of the bicycle is detected and/or the panic button 218 is actuated.

Also, the controller 232 may actuate the one or more indicators 204 of the user interface 200 in response to the detection of the traffic in front of the bicycle 100. Based on the traffic information, the controller 232 determines whether it is safe to ride or not. For example, if the controller 232 finds out heavy traffic at the front of the bicycle 100 then the red or orange light is actuated, notifying the user about the possible danger. Further, the controller 232, based on the traffic information determined from the at least one detector 202, may guide the rider in crossing a road. For example, if the user wants to cross the road and there is no traffic at front, then one or more safe cross indicators 240 of the user interface 200 is illuminated, notifying the rider to cross the road.

Moreover, the controller 232 is configured to cause actuation of a suitable turn signal indicator 238 in response to an actuation of one or the turn signal triggers 164 arranged on the handlebar grips 140, 142. For example, the controller 232 is configured to actuate a left side turn signal indicator 238a of the user interface 200 in response to the actuation of the turn signal trigger 164 of the first handlebar grip 140. Similarly, the controller 232 is configured to actuate a right-side turn signal indicator 238b of the user interface 200 in response to the actuation of the turn signal trigger 164 of the first handlebar grip 142.

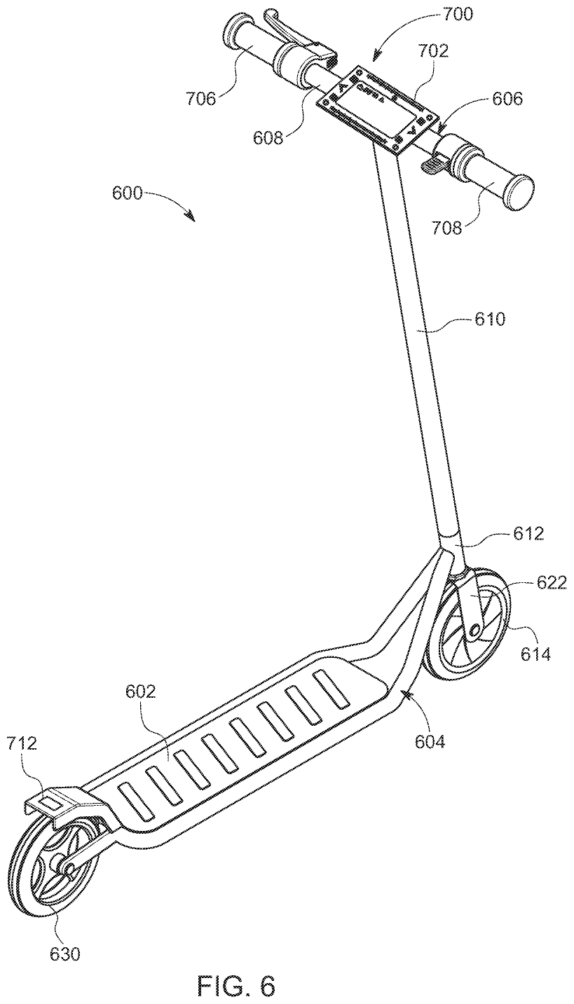

Referring to FIG. 6, a scooter 600 having a smart safety device 700 according to an alternative embodiment is shown. The scooter 600 is a play scooter adapted to be driven by a rider by applying a force on a ground using the rider's one foot, while another foot being rested on a platform 602 of the scooter 600. As shown, the scooter 600 includes a frame 604 and a handlebar assembly 606 having a handlebar 608, a steering cylinder 610 extending vertically downwardly from the handlebar 608 and extending through a head cylinder 612 of the frame 604. The steering cylinder 610 is configured to rotate inside the head cylinder 612 about its central axis to enable a rotation of a front wheel 614 in response to a turning of the handlebar 608. The handlebar assembly 606 further has a pair of spaced forks 622 arranged on each side of the front wheel 614 and connected to the front wheel 614. The forks 622 extend downwardly of the steering cylinder 610. The frame 604 also supports the platform 602, and rotatably supports at least one rear wheel 630 arranged at a rear of the scooter 600. The scooter 600 is pushed forward when the rider pushes the ground using one foot while the other foot being arranged on the platform 602. In some embodiments the scooter 600 may be operated/driven by an electrical battery powered mechanism.

The smart safety device 700 is configured to protect and keep a rider, for example, a child, safe while riding. The smart safety device 700 is similar to the smart safety device 102 except that the seat 170 is omitted from the smart safety device 700. As with the smart safety device 102 of the bicycle 100, a user interface 702 of the smart safety device 700 is arranged centrally to the handlebar 608, while handlebar grips 706, 708 of the smart safety device 700 are arranged over two lateral ends portions of the handlebar 608. The user interface 702 is similar to the user interface 200 of the smart safety device 102, while the handlebar grips 706, 708 are similar to handlebar grips 140, 142 of the smart safety device 102. Further, the smart safety device 700 includes at least one motion sensor, for example an object detector 712, arranged at the rear of the scooter 600 configured to detect object (moving or stationary) approaching the scooter 600 from the rear of the scooter 600.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific embodiments (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object-oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network includes wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

In some aspects, wireless communication interfaces may include, but are not limited to, an Intranet connection, Internet, Personal Area Networks (PANs) for the exchange of data over short distances, e.g., using short-wavelength radio transmissions in the industrial, scientific, and medical (ISM) band ISM band from 2400-2480 MHz) from fixed and mobile devices (e.g., Bluetooth® technology), wireless fidelity (Wi-Fi), Wi-Max, IEEE 802.11 technology, radio frequency (RF), Infrared Data Association (IrDA) compatible protocols, Local Area Networks (LANs), Wide Area Networks (WANs), Shared Wireless Access Protocol (SWAP), Zigbee, Near-Field Communication (NFC), LiFi, 5G, any combinations thereof, and other types of wireless networking protocols.

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### General Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A bicycle smart safety device, comprising:
a. a first handlebar grip and a second handlebar grip that are each configured to be removably mounted to a handlebar of a bicycle, wherein the first handlebar grip is arranged at a first end of the handlebar and the second handlebar grip is arranged at a second end of the handlebar, wherein the first and second handlebar grips each separately comprise a first and second grip body, a first and second grip portion, and a first and second cap portion, respectively, wherein:
i. the first grip body comprises a first object detection sensor, a first vibrator, and a first light, wherein the first object detection sensor comprises a first motion and/or proximity sensor configured to detect a presence of a first moving and/or stationary object in the vicinity of the first grip body and trigger the first vibrator and/or the first light to alert the rider to the presence of the first moving and/or stationary object; and
ii. the second grip body comprises a second object detection sensor, a second vibrator, and a second light, wherein the second object detection sensor comprises a second motion and/or proximity sensor configured to detect a presence of a second moving and/or stationary object in the vicinity of the second grip body and trigger the second vibrator and/or the second light to alert the rider to the presence of the second moving and/or stationary object;
b. a seat configured to be removably mounted on a seat post of the bicycle, comprising a seat body comprising a front end, a rear end, and first and second sides extending from the front end to the rear end, and further comprising a plurality of sensors comprising:
i. a third object detection sensor and a third vibrator that are each disposed in the first side of the seat body, wherein the third object motion detection sensor comprises a third motion and/or proximity sensor configured to detect a presence of a third moving and/or stationary object in the vicinity of the first side of the seat body and trigger the third vibrator to alert the rider to the presence of the third moving and/or stationary object;
ii. a fourth object detection sensor and a fourth vibrator that are each disposed in the second side of the seat body, wherein the fourth object motion detection sensor comprises a fourth motion and/or proximity sensor configured to detect a presence of a fourth moving and/or stationary object in the vicinity of the second side of the seat body and trigger the fourth vibrator to alert the rider to the presence of the fourth moving and/or stationary object;
iii. a fifth object detection sensor and a fifth vibrator that are each disposed in the rear end of the seat body, wherein the fifth object motion detection sensor comprises a fifth motion and/or proximity sensor configured to detect a presence of a fifth moving and/or stationary object in the vicinity of the rear end of the seat body and trigger the fifth vibrator to alert the rider to the presence of the fifth moving and/or stationary object; and
iv. a first fall and/or impact sensor disposed centrally in the seat body and configured to detect when the bicycle falls and/or when the bicycle impacts one or more objects; and
v. a pair of turn signal indicators comprising a first turn signal indicator configured to be actuated in response to actuation of a first turn signal trigger disposed in the first handlebar grip, and a second turn signal indicator configured to be actuated in response to actuation of a second turn signal trigger disposed in the second handlebar grip; and
c. a user interface removably mounted to the handlebar, comprising;
i. a sixth object detection sensor comprising a sixth motion and/or proximity sensor configured to detect a presence of a sixth moving and/or stationary object in the vicinity of the user interface and trigger at least one indicator disposed within the user interface to alert the rider to the presence of the sixth moving and/or stationary object, wherein the at least one indicator comprises one or more lights configured to be actuated in response to input received from the sixth motion and/or proximity sensor;
ii. a front camera configured to capture a view in front of the bicycle and a rear camera configured to capture a view of the rider; wherein the front and rear cameras are configured to be in communication with a mobile device of a guardian of the rider and share images and/or video to the mobile device;
iii. at least one speaker configured to be paired with the mobile device of the guardian and enable audio and/or voice communication from the guardian to the rider, and wherein the at least one speaker is also configured to provide audio alerts to the rider based on input from the sixth motion and/or proximity sensor;
iv. a second fall and/or impact sensor configured to detect when the bicycle falls and/or when the bicycle impacts one or more objects;
v. a panic button adapted to be operated by the rider and configured to trigger a distress signal that is transmitted to the mobile device when the panic button is operated to inform the guardian that the rider needs help;
vi. a headlight configured to illuminate an area in front of the bicycle;
vii. a location sensor configured to determine a location of the bicycle and transmit the location to the mobile device to enable the guardian to monitor the location of the bicycle in real time;
viii. a transceiver configured to facilitate a communication and date exchange between the mobile device and a controller; and
ix. a controller comprising a processor operatively connected to a memory for storing instructions for controlling functions of the safety device, wherein the controller is configured to:
aa. receive input from the first, second, third, fourth, and/or fifth object detection sensors and actuate the first, second, third, fourth, and/or fifth vibrators, respectively, when the first, second, third, fourth, and/or fifth moving and/or stationary objects are detected, wherein the controller is further configured to control a frequency and intensity of vibration based on a distance of the first, second, third, fourth, and/or fifth moving and/or stationary objects from the bicycle;
bb. receive input from the first and/or second fall and/or impact sensors and communicate the occurrence of a fall and/or impact and/or the location of the bicycle to the mobile device through the transceiver;
cc. facilitate a voice-based communication between the guardian and the rider through the speaker via the mobile device;
dd. communicate the distress signal and/or the location of the bicycle to the mobile device in response to the actuation of the panic button by the rider;
ee. communicate the location of the bicycle to the mobile device when a fall and/or impact is detected and/or when the panic button is actuated;
ff. receive input from the first, second, third, fourth, and/or fifth object detection sensors, determine whether it is safe to ride or not, and actuate the one or more indicators to notify the rider of traffic and/or guide the rider to navigate through and/or around traffic; and
gg. receive input from the first and/or second turn signal triggers and actuate the respective first and/or second turn signal indicators.

2. The bicycle smart safety device of claim 1, wherein the grip body has a substantially hollow cylindrical shape and is configured to receive a portion of the handlebar.

3. The bicycle smart safety device of claim 1, wherein the grip portion is adapted to be held by a rider.

4. The bicycle smart safety device of claim 1, wherein the cap portion is arranged at an end of the grip portion.

5. The bicycle smart safety device of claim 1, wherein in response to the receipt of the distress signal, the user interface enables voice communication from the guardian via the mobile device to the rider via the at least one speaker.

6. The bicycle smart safety device of claim 1, wherein the front camera and/or rear camera are configured to make a recording of the fall and/or impact and communicate the recording to the guardian via the mobile device.

7. The bicycle smart safety device of claim 1, wherein the location sensor comprises a global positioning system.

8. The bicycle smart safety device of claim 1, wherein if the controller determines that it is not safe to ride, the one or more indicators comprise a warning light.

9. A scooter smart safety device, comprising:
a. a first handlebar grip and a second handlebar grip that are each configured to be removably mounted to a handlebar of a scooter, wherein the first handlebar grip is arranged at a first end of the handlebar and the second handlebar grip is arranged at a second end of the handlebar, wherein the first and second handlebar grips each separately comprise a first and second grip body, a first and second grip portion, and a first and second cap portion, respectively, wherein:
i. the first grip body comprises a first object detection sensor, a first vibrator, and a first light, wherein the first object detection sensor comprises a first motion and/or proximity sensor configured to detect a presence of a first moving and/or stationary object in the vicinity of the first grip body and trigger the first vibrator and/or the first light to alert the rider to the presence of the first moving and/or stationary object; and
ii. the second grip body comprises a second object detection sensor, a second vibrator, and a second light, wherein the second object detection sensor comprises a second motion and/or proximity sensor configured to detect a presence of a second moving and/or stationary object in the vicinity of the second grip body and trigger the second vibrator and/or the second light to alert the rider to the presence of the second moving and/or stationary object; and
b. a third object detection sensor positioned on a rear portion of the scooter, comprising a third motion and/or proximity sensor configured to detect a presence of a third moving and/or stationary object in the vicinity of the rear portion of the scooter and trigger at least one indicator disposed within the user interface to alert the rider to the presence of the third moving and/or stationary object, wherein the at least one indicator comprises one or more vibrators and/or one or more lights configured to be actuated in response to input received from the third motion and/or proximity sensor;
c. a user interface removably mounted to the handlebar, comprising;
i. a front camera configured to capture a view in front of the scooter and a rear camera configured to capture a view of the rider; wherein the front and rear cameras are configured to be in communication with a mobile device of a guardian of the rider and share images and/or video to the mobile device;
ii. at least one speaker configured to be paired with the mobile device of the guardian and enable audio and/or voice communication from the guardian to the rider, and wherein the at least one speaker is also configured to provide audio alerts to the rider based on input from the sixth motion and/or proximity sensor;
iii. a fall and/or impact sensor configured to detect when the scooter falls and/or when the scooter impacts one or more objects;
iv. a panic button adapted to be operated by the rider and configured to trigger a distress signal that is transmitted to the mobile device when the panic button is operated to inform the guardian that the rider needs help;
v. a headlight configured to illuminate an area in front of the scooter;
vi. a location sensor configured to determine a location of the scooter and transmit the location to the mobile device to enable the guardian to monitor the location of the scooter in real time;
vii. a transceiver configured to facilitate a communication and date exchange between the mobile device and a controller; and
viii. a controller comprising a processor operatively connected to a memory for storing instructions for controlling functions of the safety device, wherein the controller is configured to:
aa. receive input from the first, second, third, fourth, and/or fifth object detection sensors and actuate the first, second, third, fourth, and/or fifth vibrators, respectively, when the first, second, third, fourth, and/or fifth moving and/or stationary objects are detected, wherein the controller is further configured to control a frequency and intensity of vibration based on a distance of the first, second, third, fourth, and/or fifth moving and/or stationary objects from the scooter;
bb. receive input from the first and/or second fall and/or impact sensors and communicate the occurrence of a fall and/or impact and/or the location of the scooter to the mobile device through the transceiver;
cc. facilitate a voice-based communication between the guardian and the rider through the speaker via the mobile device;
dd. communicate the distress signal and/or the location of the scooter to the mobile device in response to the actuation of the panic button by the rider;
ee. communicate the location of the scooter to the mobile device when a fall and/or impact is detected and/or when the panic button is actuated; and
ff. receive input from the first, second, and/or third object detection sensors, determine whether it is safe to ride or not, and actuate the one or more indicators to notify the rider of traffic and/or guide the rider to navigate through and/or around traffic.

10. The scooter smart safety device of claim 9, wherein the grip body has a substantially hollow cylindrical shape and is configured to receive a portion of the handlebar.

11. The scooter smart safety device of claim 9, wherein the grip portion is adapted to be held by a rider.

12. The scooter smart safety device of claim 9, wherein the cap portion is arranged at an end of the grip portion.

13. The scooter smart safety device of claim 9, wherein in response to the receipt of the distress signal, the user interface enables voice communication from the guardian via the mobile device to the rider via the at least one speaker.
